(19) United States
(12) Patent Application Publication
(10) Pub. No.: US 2015/0233868 A1
(43) Pub. Date: Aug. 20, 2015

(54) Differential Sensor, Inspection System and Method for the Detection of Anomalies in Electrically Conductive Materials

(71) Applicant: Institut Dr. Foerster GmbH & Co.KG, Reutlingen (DE)

(72) Inventors: Mladen Zec, Nuernberg (DE); Robert Uhlig, Bad Urach (DE); Marek Ziolkowski, Plaue (DE); Hartmut Brauer, Langewiesen (DE)

(21) Appl. No.: 14/426,211

(22) PCT Filed: Sep. 4, 2013
(86) PCT No.: PCT/EP2013/068268

§ 371 Date: Mar. 5, 2015

(30) Foreign Application Priority Data
Sep. 6, 2012 (DE) 10 2012 017 871.9

(51) Int. Cl. G01N 27/90

(52) U.S. Cl. CPC G01N 27/90

(57) ABSTRACT

A differential sensor for the detection of anomalies in electrically conductive materials has a permanent magnet, a first coil with one or more first windings, which run around the permanent magnet and define a first coil axis, and a second coil with one or more second windings, which run around the permanent magnet and define a second coil axis, which runs transversely, in particular perpendicularly, to the first coil axis. Preferably, a third coil, oriented perpendicularly thereto, is also provided. Components of changes in the magnetic flux can be sensed separately for multiple spatial directions and evaluated. The sensor is part of an inspection system, which includes the sensor and an evaluation device, which is configured for sensing separately for each coil electrical voltages induced in the windings of the coils of the differential sensor, or signals derived therefrom, and correlating them by applying at least one evaluation method.

### BACKGROUND AND PRIOR ART

The invention relates to a differential sensor, an inspection system and a method for the detection of anomalies in electrically conductive materials.

The non-destructive detection of anomalies in materials is highly important in the present day. Anomalies may be, for example, a defect such as a crack, an impurity or some other material inhomogeneity, for example a local non-uniformity of the electrical conductivity. A great need for materials with a high load-to-mass ratio requires a particularly high quality of the materials. In order to save costs and determine the quality of each item produced, there has been increasing use of non-destructive methods for the detection and localization of defects and for the determination of material parameters. Since metallic materials play a special role for industry, the non-destructive investigation of electrically conductive materials is the subject of research, development and application.

In non-destructive material testing (non-destructive testing, NDT), many different methods are used nowadays, depending on the type of test piece and the properties of the material under investigation that are sought. According to the article “From Fifteen to Two Hundred NDT Methods in 50 years” by T. Aastroem in: 17th World Conference on Non-destructive Testing, 2008, over 200 methods for non-destructive material testing are known from the prior art.

Electromagnetic methods in particular have proven successful for the detection of anomalies in electrically conductive materials. However, some of the methods available are limited in resolution, penetration depth and run-through time or testing rate. But also the probability of identifying a defect as such should be further increased.

The arrangement of sensors in sensor arrays of varying size makes it possible to reconstruct defects with the aid of corresponding algorithms. However, such an arrangement presupposes a compact construction of the sensors.

Eddy current testing (ECT) has proven successful for the inspection of electrically conducting materials in many application areas, for example in the automated non-destructive testing of semifinished products for the metal-producing and metal-processing industry, for carrying out tests on components that are relevant to safety and functionally critical for land vehicles and aircraft or in plant construction.

A conventional eddy current sensor, constructed with coils, comprises one or more field coils (or excitation coils), which are connected to an alternating voltage source for carrying out the test and can then generate an alternating electromagnetic field (primary field), which during the test penetrates into the material under test and by counterinduction generates eddy currents, substantially in a layer near the surface of the material under test, the eddy currents having a retroactive effect on one or more measuring coils (or receiver coils) of the eddy current probe. A defect in the region tested, for example a crack, an impurity or some other material inhomogeneity, disturbs the propagation of the eddy currents in the material under test and consequently changes the eddy current intensity, and thereby also the intensity of the secondary magnetic field acting retroactively on the measuring coils. The changes in the electrical properties thereby caused in a measuring coil, for example the impedance, lead to electrical measuring signals in the form of electrical voltage changes, which can be evaluated by means of an evaluation device in order to identify and characterize defects. Eddy current sensors may also be used on defect-free material for inspection purposes or measuring purposes, for example in the case of measurements of the electrical conductivity or the magnetic permeability.

Eddy current testing allows inspection for defects near the surface with a high degree of sensitivity and spatial resolution. A high spatial resolution with high testing rates is shown in particular by the application of what is referred to as “motion-induced remote field eddy current testing”, described in the article “Application of Motion Induced Remote-Field Eddy Current Effect to Online Inspection and Quality Examination of Rolling Metallic Strips” by Sun, Y., Udpa, S., Lord, W., Udpa, L. and Ouyang, T. in: AIP Conf. Proc. 557 (2001) pages 1541-1548.

Imaging methods, described for example in the article “Electromagnetic Imaging Using Probe Arrays” by: Mook, G., Michel, F. and Simonin, J. in: Strojni\check{s}ki vestnik—Journal of Mechanical Engineering 57 (2011) 3, pages 227-236, show a high degree of sensitivity to anomalies in the material under investigation.

The use of alternating magnetic fields for generating the primary magnetic field penetrating into the material of the test piece has the disadvantage of a frequency-limited penetration depth into the material under investigation. Deeper-lying anomalies and depths of slit-like anomalies therefore cannot generally be determined sufficiently well if the depth exceeds three times the penetration depth (see article “Deep Penetrating Eddy Currents and Probes” by Mook, G., Hesse, O. & Uchanin, V. in: 9th European Conference on Non-Destructive Testing, 2006). It has been observed that even anomalies at a depth that corresponds approximately to the penetration depth can, however, present problems for sensor systems of this type. With the frequency-dependent penetration depth there is a corresponding spatial resolution of the sensor system used. If it is wished to detect deep-lying anomalies, a lower frequency is necessary. Accordingly, only lower testing rates are possible, as a result of which the run-through time of the object of investigation through the sensor system is increased.

There are numerous documents in which methods and sensors for the detection of defects are described, a relative movement between a sensor and the material under investigation being realized.

The article “A new NDT method based on permanent magnetic field perturbation” by Sun, Y., Kang, Y. and Quio, C. in: NDT & E International 44 (2011) pages 1-7 describes a non-destructive method for inspecting ferromagnetic materials by means of flux leakage testing. A permanent magnet that is aligned perpendicularly to the surface of the component to be tested is wound around by a receiver coil. This allows observation of what is referred to as the PMFP effect (permanent magnetic field perturbation effect) when the magnet in this perpendicular alignment is made to move along the surface of the test piece at a defined distance from the surface. The method is intended to be capable of allowing differently oriented defects in ferromagnetic materials to be detected with sufficient sensitivity.

The U.S. Pat. No. 7,023,205 B1 describes an eddy current sensor that is capable of detecting electrically conducting components through an electrically conductive barrier. The sensor comprises a permanent magnet that is wound around by a coil. The eddy current sensor may be mounted on the outside of the housing for a turbine or some other machine with rotating components, in order to measure the properties of electrically conductive components moved along the inner side of the housing, for example turbine blades, through the housing.

WO 00/58695 presents a method for measuring parameters of metallic objects in which the force acting on the metallic object is determined. A metallic object is in this case understood as meaning both a metallic fluid and a metallic solid body with finite dimensions.

The U.S. Pat. No. 6,002,251 presents a sensor arrangement for measuring the “remote field” with the aid of eddy current sensors, a local separation of excitation coil and receiver coil and a magnetic shielding of the excitation system being realized.

WO 2007/053519 A2 describes the detection of defects with the aid of a drag force that acts on a magnet when the latter is moved in relation to a test object.

In recent years, a novel contactless non-destructive material testing method known by the term “Lorentz Force Eddy Current Testing” (LET) has been developed at Ilmenau University of Technology. Basic principles are described for example in the article: “Eddy Current Testing of Metallic Sheets with Defects Using Force Measurements” by Brauer, H., Ziolkowski, M. in: Serbian Journal of Electrical Engineering 2008, 5, pages 11-20. If a metallic test piece and a permanent magnet are set in relative motion in relation to one another, eddy currents are induced in the test piece and in turn cause a Lorentz force, which brings about a corresponding counterforce on the magnet system. An inhomogeneity of the electrical conductivity of the material of the test piece, for example caused by a crack or some other defect, is manifested in a change in the Lorentz force, which can be detected with the aid of a force sensor on the magnet system. Lorentz force eddy current testing makes it possible to detect deeper-lying defects on the basis of measurements of the Lorentz forces acting on the magnet system.

DE 10 2011 056 650 A1 describes a method and an arrangement for determining the electrical conductivity of a material on the basis of Lorentz force eddy current testing. This exploits the fact that the Lorentz force comprises multiple force effects in different directions. A first force effect and a second force effect, acting in a different direction, are measured and associated values are calculated by forming a quotient. The method may also be used for the purpose of localizing inhomogeneities in the material.

In spite of the great variety of existing sensor systems for non-destructive material testing, there is still a need for sensors and sensor systems that allow anomalies to be reliably detected with a high degree of sensitivity. In particular, the detection of deeper-lying anomalies in the material under investigation with high testing rates continues to present a problem that has not been solved satisfactorily.

### PROBLEM AND SOLUTION

A problem addressed by the invention is that of providing a differential sensor, an inspection system and a method for the detection of anomalies in electrically conductive materials that allow anomalies to be detected with a high degree of sensitivity and a low misdetection rate even at high testing rates, it also being possible for the detection of deeper-lying anomalies in the material under investigation to be realized.

To solve this and other problems, a differential sensor is provided. Furthermore, an inspection system is provided. The problem is also solved by a method for the detection of anomalies in electrically conductive materials, which can be carried out using the sensor and/or the inspection system.

According to one aspect, the claimed invention provides a differential sensor for the detection of anomalies in electrically conductive materials. For the purpose of generating eddy currents in the material to be tested, the sensor includes a (at least one) permanent magnet. If a permanent magnet is used instead of an excitation coil operated with alternating current, the penetration depth of the (primary) magnetic field in the material can be increased. This makes it possible even to detect anomalies lying deeper under the surface of the material.

For the generation of sensor signals, the sensor has a first coil with one or more first windings, which run around the permanent magnet and define a first coil axis, and a second coil with one or more second windings, which run around the permanent magnet and define a second coil axis, the second coil axis running transversely to the first coil axis. The coils therefore have coil axes that do not lie parallel to one another but are at a finite angle in relation to one another. The term “coil axis” refers here to a direction that lies substantially perpendicularly to a winding plane defined by the path followed by a winding. The orientations of the coils may also be defined by coil planes that are perpendicular to the respective coil axes and likewise lie transversely to one another.

The secondary magnetic field, caused by the induced eddy currents, interacts with the primary magnetic field, provided by the permanent magnet. So if during the relative movement an anomaly passes through the region that is influenced by the primary magnetic field, the secondary magnetic field is disturbed by this anomaly and an electrical voltage is induced in each of the (at least) two coils by the associated change in the magnetic flux.

The term “differential sensor” in this connection describes the capability of the sensor to sense changes over time in the magnetic flux φ by sensing electrical voltages induced in the windings or in the coils. Since this change over time t can be described by the differential dφ/dt, the sensor is referred to as a “differential sensor”. One of the ways in which a “differential” sensor is distinguished from the known eddy current differential probes is that, in the case of eddy current differential probes, axially parallel coils are connected to one another in pairs in a differential connection (for example by means of an opposing winding direction) in order to obtain a differential signal, whereas the coils of a “differential sensor” are not connected to one another in a differential connection but generate signals that are independent from one another and can also be evaluated independently from one another.

Since at least two different coils (first coil and second coil) are provided, the coil axes of which do not run parallel to one another but are aligned transversely to one another, the changes over time in the magnetic flux can be sensed separately for multiple spatial directions. The provision of two (or more) coils with non-parallel coil axes consequently allows mutually independent sensing of components of the change in the magnetic flux in multiple spatial directions. On account of this functionality, the sensor may also be referred to as a “multi-component sensor”, the term “component” relating here to the components of the change in the magnetic flux in different spatial directions.

It has been found that such a multi-component sensor can reduce the probability of false readings in comparison with corresponding sensors with only one coil, since the change in the magnetic flux can be sensed simultaneously in multiple spatial directions. Consequently, the sensor signals can be used as a basis for distinguishing “true” defects, such as for example cracks or voids, from pseudo-defects, which for example only generate significant changes in the magnetic flux in one of the coils.

Although two coils may be sufficient for the multi-dimensional sensing of the changes in the magnetic flux, in the case of a preferred embodiment a third coil is provided, with one or more third windings, which run around the permanent magnet and define a third coil axis, which runs transversely to the first coil axis and to the second coil axis. Consequently, an even more precise breakdown of the change over time in the magnetic flux into the different spatial directions or components is possible. A sensor preferably has precisely three non-coaxial coils.

In the case of preferred embodiments, the coil axes of the coils are alternately oriented perpendicularly to one another, whereby a separation of the overall change in the magnetic flux into its components in three directions of a Cartesian system of coordinates is possible. This has the effect of simplifying the evaluation greatly. It would also be possible to orient the first coil, the second coil and, if applicable, the third coil in relation to one another in such a way that the coil axes have different angles in relation to one another, for example 60° angles or 30° angles or the like.

Generally, embodiments in which the first coil, the second coil and/or the third coil is/are fixed to the permanent magnet are favorable. A mechanically fixed connection between the permanent magnet and the coils has the effect of ensuring that no relative movement between the permanent magnet and the coils is possible, so that the primary magnetic field of the permanent magnet cannot induce voltages in the coils during operation, and consequently all of the voltages induced in the coils are attributable exclusively to the secondary magnetic field, which is induced by the induced eddy currents in the material. However, it would also be possible not to fix one or more of the coils directly to the permanent magnet, but to another component of the sensor that is preferably coupled to the permanent magnet in a mechanically fixed manner.

The fixing of the coils to the permanent magnet also makes it possible to construct compact sensors with particularly small spatial dimensions, which only require a correspondingly small installation space. The construction is also inexpensive, since, apart from a permanent magnet and the coils, no further electrical/magnetic components are necessary. The compact construction also makes such sensors particularly suitable for use in sensor arrays, that is to say in sensor systems with multiple sensors that are relatively close to one another in a one-dimensional or two-dimensional arrangement, in order for example to be able to sense relatively extensive regions of a material to be tested simultaneously. In the case of some embodiments, multiple differential sensors form a one-dimensional or two-dimensional sensor array.

If differential sensors according to the invention are compared with sensors for the Lorentz force eddy current testing described above, it can be noted that differential sensors according to the invention detect a change in the magnetic flux, whereas in the case of Lorentz force eddy current testing the absolute values of the force acting on the magnet system are recorded by corresponding force sensors and evaluated. However, while mechanical force measuring systems have only relatively limited dynamics on account of the measuring conditions, because mechanical changes in the system have to be generated for the force measurement, there is no such restriction on the measuring dynamics in the case of inductive sensors according to the invention. Consequently, measurements at higher testing rates are possible in comparison with Lorentz force eddy current testing.

It can be theoretically shown that the change in the Lorentz forces that is used for measurement in the case of Lorentz force eddy current testing correlates directly with changes in the magnetic flux, so that discoveries that have been obtained in connection with the evaluation of signals of Lorentz force eddy current testing can possibly also be used in the testing with differential sensors according to the invention that is claimed.

In the case of some embodiments, in addition to the differential sensor, a force sensor is provided and is mechanically coupled to the differential sensor in such a way that Lorentz forces acting on the differential sensor can be sensed in multiple spatial directions by means of the force sensor. As a result, a combination sensor or a sensor combination is created. Such a coupling to a force pickup makes it possible for two different methods to be carried out at the same time, it being possible in one method of inspection for defects to be sensed with the aid of the differential sensor by way of the change in the magnetic flux (dφ/dt) that is sensed in multiple spatial directions, and it being possible at the same time for the electrical conductivity to be sensed in different spatial directions in a measuring method on the same test volume by the expedient correlation of Lorentz force components.

A differential sensor of the type described here may for example be used in combination with a method and an arrangement for determining the electrical conductivity of a material according to the aforementioned DE 10 2011 056 650 A1, the disclosure content of which is to this extent made the content of the present description by reference.

The invention also relates to an inspection system for the detection of anomalies in electrically conductive materials, the inspection system having at least one differential sensor of the type described above. In test operation, the sensor is connected to an evaluation device, which is configured for sensing separately for each coil electrical voltages induced in the windings of the at least two coils, or signals derived therefrom, and correlating them by applying at least one evaluation method.

For example, the evaluation device may be designed only to generate a defect signal, indicating a defect, or a defect indication based thereon whenever a change in voltage that is typical of a defect is induced both in the first coil and in the second coil. This allows the rate of misdetections to be reduced.

If a multi-dimensionally acting force sensor of the type mentioned, mechanically coupled to the differential sensor, is also provided, an evaluation device is provided for the evaluation of signals of the force sensor for multiple spatial directions.

The invention also relates to a method for the detection of anomalies in electrically conductive materials, in which a differential sensor or an inspection system with such a sensor is used. In this case, a (at least one) differential sensor is arranged in the vicinity of a surface of a test object of electrically conductive material in such a way that a magnetic field generated by the permanent magnet can penetrate into the test object to a penetration depth. A relative movement between the differential sensor and the test object parallel to a direction of movement is generated. This is possible by moving the test object with the sensor at rest or moving the sensor with the test object at rest or by a combination of movements of the test object and the sensor. The distance between the sensor and the surface of the test piece should in this case be as constant as possible. The relative movement has the effect of generating eddy currents in the material, in the region in which the magnetic field acts, the secondary magnetic field of the eddy currents acting on the coils of the differential sensor. The electrical voltages induced in the windings of the coils of the differential sensor, or signals derived therefrom, are sensed separately for each coil and evaluated by applying at least one evaluation method, whereby anomalies in electrically conductive materials can be detected.

These and other features emerge not only from the claims but also from the description and the drawings, where the individual features can be realized in each case by themselves or as a plurality in the form of subcombinations in an embodiment of the invention and in other fields and can constitute advantageous and inherently protectable embodiments. Exemplary embodiments of the invention are represented in the drawings and are explained in more detail below.

### BRIEF DESCRIPTION OF THE DRAWING FIGURES

FIG. 1 shows an embodiment of an inspection system with a differential sensor according to one embodiment of the invention in test operation;

FIG. 2 schematically shows an embodiment of a three-dimensionally acting differential sensor;

FIG. 3 schematically shows an embodiment of a two-dimensionally acting differential sensor;

FIGS. 4A and 4B schematically show measuring signals of conventional Lorentz force eddy current testing without a defect (-) and with a defect ( - - - ), where FIG. 4A shows the force signal in the direction of movement of the material and FIG. 4B shows the force signal in the lifting direction;

FIGS. 5A and 5B show induced voltage signals in the case of a differential sensor according to one embodiment of the invention, where FIG. 5A shows the signal of a coil with a coil axis in the x direction (direction of movement) and FIG. 5B shows the signal of a coil with a coil axis in the z direction (lifting direction);

FIG. 6 schematically shows an inspection system that is configured for a combination of Lorentz force eddy current testing and differential eddy current testing;

FIG. 7 shows a two-dimensional sensor array with a multiplicity of identical differential sensors; and

FIG. 8 shows an inspection system with a sensor system that has two differential sensors, which for the purpose of distance compensation are arranged at different inspection distances from the test object.

### DETAILED DESCRIPTION OF PREFERRED EMBODIMENTS

The schematic FIG. 1 shows an embodiment of an inspection system with a differential sensor according to one embodiment of the invention in test operation when carrying out a method for the detection of anomalies in a test object OBJ, which consists of an electrically conducting material, at least in the region of a surface OB, possibly also completely.

In the case of this inspecting or measuring arrangement, the inspection system is at rest with respect to the spatially fixed Cartesian system of coordinates KS, while the test object is moved in relation thereto at a speed v in a direction of movement R in the x direction. The test object, for example a plate or a strip of steel, aluminum or some other ferromagnetic or non-ferromagnetic metal, contains in the case of the example a hidden defect D1, which does not reach up to the surface OB of the test object and lies at a certain depth, and also a defect D2 near the surface in the form of a void, which reaches up to the surface OB.

The inspection system SYS has a differential sensor SENS1, which is connected to an evaluation device A. The sensor SENS1 has a permanent magnet PM, which in the case of the example is a cuboidal piece of a rare-earth magnet. For carrying out the inspection, the permanent magnet is brought into the vicinity of the test object and oriented in such a way that its magnetic axis, that is to say the joining line between the magnetic north pole N and the magnetic south pole S, is as perpendicular as possible to the surface OB of the test object.

The sensor has a first coil S1 with one or more first windings, which run around the permanent magnet and define a first coil axis (oriented perpendicularly to the windings), which in the case of the example runs parallel to the magnetic axis of the permanent magnet or parallel to the z direction. Also provided is a second coil S2 with one or more second windings, which run around the permanent magnet and define a second coil axis, which runs perpendicularly to the first coil axis, to be precise in the x direction, which during the inspection is oriented as parallel as possible to the direction of movement R. In addition, a third coil S3 is provided, likewise having one or more windings, which run around the permanent magnet and define a third coil axis, which runs perpendicularly to the first and second coil axes, possibly parallel to the y direction.

The three coil axes, or the coil planes lying perpendicularly to the respective coil axes, therefore lie alternately perpendicularly to one another. In the case of the example, the coils are wound from insulated wire and are electrically insulated from one another. The coils are fixed to the permanent magnet, for example by means of adhesive, so that a relative movement with respect to the magnet is not possible. The arrangement comprising the permanent magnet and the coils may be cast in an electrically non-conducting, non-magnetizable polymer compound, which for reasons of simplicity are not shown. The coils are each connected separately from one another to the evaluation device A, each of the coils being assigned an input channel of its own.

The inspection system is capable of detecting changes over time in the magnetic flux φ in the region sensed by the coils, in that the electrical voltages induced in the windings of the individual coils are sensed by means of the evaluation device and evaluated. The changes over time in the magnetic flux can be sensed separately for the three spatial directions of a Cartesian system of coordinates. Components of the change in the magnetic flux in the z direction are sensed by the first coil S1 and correspondingly induce in it an electrical voltage U_{z}. Components of the change in the magnetic flux in the x direction, that is to say more or less parallel to the direction of movement R of the test object, generate a corresponding electrical voltage Uₓ in the second coil S2. Components which, perpendicularly to the said components, are directed parallel to the y direction, that is to say in the transverse direction of the movement, generate a corresponding voltage U_{y} in the third coil S3. The individual voltages are sensed separately in the evaluation device and can then be correlated with one another with the aid of different evaluation methods.

Since the sensor SENS1 is capable of sensing changes over time in the magnetic flux, that is to say a differential dφ/dt, separately in multiple spatial directions, it is also referred to as a “differential multi-component sensor”.

FIG. 2 schematically shows one possible configuration of the three-dimensionally acting sensor SENS1 from FIG. 1. The windings of the first coil S1 and of the second coil S2 are each wound directly on the outer circumference of the permanent magnet, in directions that are perpendicular to one another, while the winding of the third coil S3 is wound perpendicularly to the windings of the other two coils around them. An inverse arrangement is also possible.

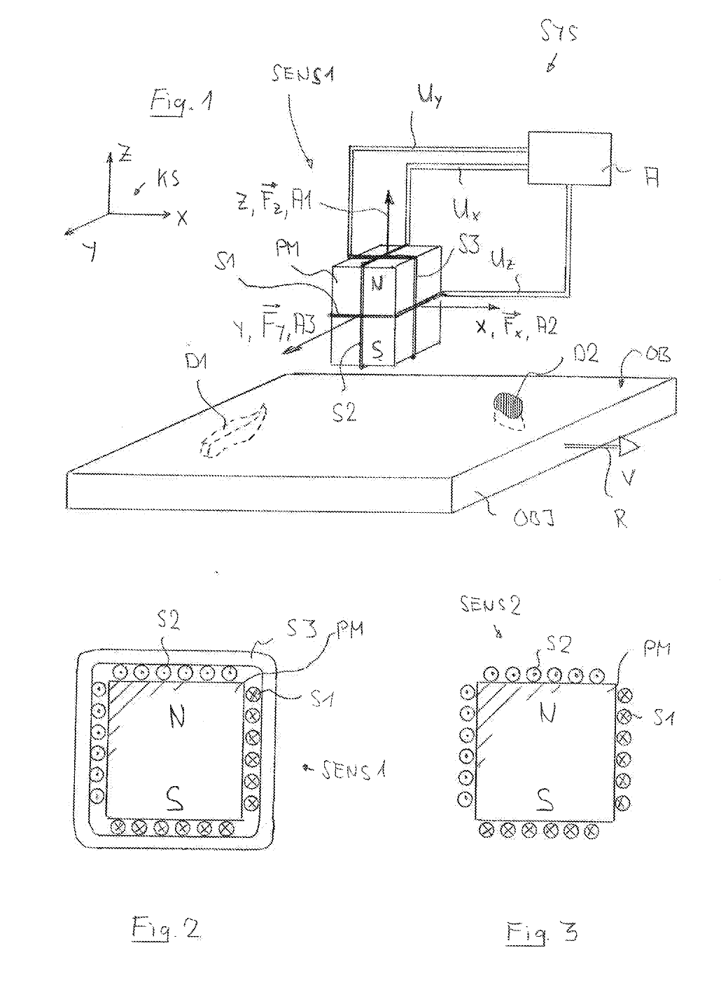

FIG. 3 shows a simplified variant of a sensor SENS2, which merely has a first coil S1 and a second coil S2, so that only two components of the change in the magnetic flux can be sensed in two spatial directions that are perpendicular to one another. This may be sufficient for many measuring or testing purposes.

The functional principle of the sensor or the inspection system can be described as follows. By relative movement between the permanent magnet PM wound with coils and the test object of electrically conductive material, eddy currents are induced in the test object by the magnetic field of the permanent magnet. These eddy currents in turn generate a secondary magnetic field, which interacts with the primary magnetic field of the permanent magnet and is superposed on it. The coils “see” the superposed field as a whole (primary field and secondary field), but with only changes in the secondary field being registered in the coils as induced voltages. Anomalies in the test object cause a change in the magnetic flux in the region of the coils, and can consequently be sensed by the differential sensor.

In comparison with conventional eddy current testing (excitation of the primary field by means of excitation coils through which a current flows), the method of inspection, the inspection system and the sensor offer several advantages, which could also be achieved by the Lorentz force eddy current testing described at the beginning, including an increased penetration depth. However, further advantages are obtained in comparison with Lorentz force eddy current testing, especially with regard to the higher possible dynamics of the testing (greater testing rates) and the avoidance of misdetections. For better understanding, some of the common features and essential differences of the two methods and sensor systems are explained below.

As already mentioned, in the case of Lorentz force eddy current testing, a constant magnetic field, which is generated for example by a permanent magnet or a coil operated with direct current, is used for generating the eddy currents in the material to be tested. The change over time in the magnetic field during the interaction with the material is produced by generating a relative speed between the test object and the constant field source.

According to Ohm's law for moved charge carriers, with a magnetic flux density B and a speed v of the relative movement, eddy currents with current density j are induced in the test object:

\vec{j}=σ·(\vec{v}×\vec{B})

The eddy currents for their part interact again with the primary constant field. This interaction in a volume V of the material leads to a force effect on the material to be tested, which is referred to as the Lorentz force F_{LF}:

$${\vec{F}}_{LF} = {\int \int \int }_{( V )} ( \vec{j} \times \vec{B} ) d V$$

In accordance with Newton's third law “action=reaction”, there must be a second force, which acts retroactively on the cause of the Lorentz force, that is to say on the source of the primary magnetic field, to be specific the permanent magnet PM. The force is a vectorial value and has three spatial directions. In FIG. 1, the corresponding force components Fₓ, F_{y} and F_{z} are depicted in the x, y and z directions. If the material to be tested does not contain a defect, the paths of the eddy currents are undisturbed and the Lorentz force is constant. If a defect disturbs the paths of the eddy currents, changes in force are induced and can be measured.

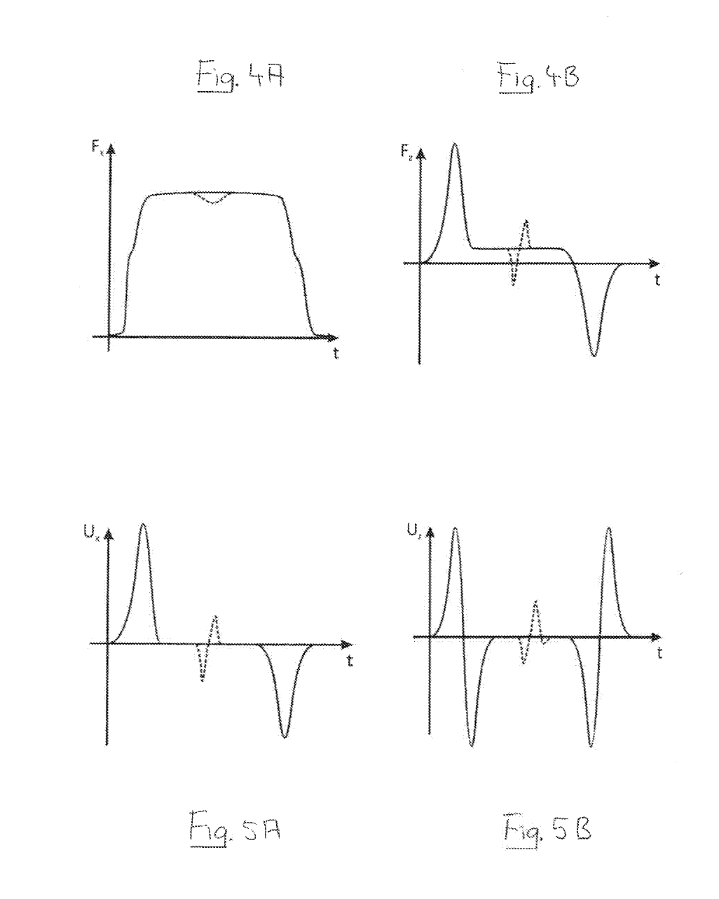

FIG. 4 shows for purposes of illustration typical measuring signals of Lorentz force eddy current testing without a defect (solid line) and with a defect (dashed line), where 4A shows the force signal in the direction of movement of the material (x axis) and 4B shows the force signal in the lifting direction (z axis).

Since the primary magnetic field is a constant field, the penetration depth of the eddy currents into the material is determined by the relative speed and not, as in the case of classical eddy current testing, primarily by the excitation frequency. As a result, defects can be potentially detected at greater depths under the same measuring conditions.

Forces can be measured merely on the basis of their effect. It is customary to use mechanical deformation bodies, on which strain and compression are taken as a basis for calculating back to the forces acting. In terms of structural mechanics, these deformation bodies tend to be of low stiffness. For this reason, the natural frequency is often in the lower Hz range. Since high measuring rates require high dynamics of the measuring system, systems with low natural frequencies are not suitable. The disturbance is simply not picked up by the system if it takes place in a short time period (vibration isolation).

The permanently acting Lorentz force may likewise have disadvantageous effects on the inspection system. The sensor equipment must cover a correspondingly great measuring range. The disturbance that indicates a defect is small in comparison with the Lorentz force acting. Correspondingly, a high resolution must be ensured. The two demands (measuring range, resolution) are contrary and represent a conflict of objectives that normally can only be resolved by technical compromises.

By contrast with classical eddy current testing, Lorentz force eddy current testing is only conditionally suitable for the testing of ferromagnetic materials. The high forces of attraction between the magnet and the test material must be compensated. Otherwise, the Lorentz force, and in particular the disturbances due to the forces of attraction, are superposed and cannot be detected satisfactorily.

Lorentz force eddy current testing is not limited by a frequency-dependent penetration depth but by a speed-dependent penetration depth. The speed limitation is noticeable as from speeds of 1 m/s by the way in which the force effect behaves in a non-linear manner. The method is potentially suitable for the detection of defects in non-ferromagnetic materials that penetrate the surface or are located near the surface. The specific electrical conductivity of the test material can be determined with the aid of two measured force components (cf. DE 10 2011 056 650 A1).

In order to overcome the described conflict of objectives of inspection with Lorentz force eddy current testing, it would be possible to sense only the change over time in the force signal. The change in a signal may be determined on the one hand by a differential arrangement that requires two identical measuring systems, one of which examines a defect-free part of the material to be tested, while the other passes over a defect; on the other hand, a change may be determined by the time derivative (differential) of a signal.

It has been recognized that it is problematic to determine the time derivative from the force signal, since in this case the noise increases. It is better to measure a physical value that is linked to the Lorentz force by the change over time.

The force signal is generated by the magnetic field as a whole, which is produced by the interaction of the primary magnetic field and the secondary magnetic field. The change over time in the secondary magnetic field also brings about the change over time in the magnetic field as a whole. The primary constant component has no influence on the time derivative. The secondary magnetic field changes as a reaction to disturbed eddy current paths. This change over time in the magnetic field can be measured by various sensors, for example induction coils. In a coil with a number of windings N and a coil area A, the change over time in the magnetic flux generates an electrical voltage U:

$$U = N \cdot \frac{d Φ}{d t} = N \cdot \frac{d}{d t} ( {\int }_{( A )} \vec{B} \cdot d \vec{A} )$$

It can be shown that this voltage is proportional to the corresponding component that is the Lorentz force.

The voltage thus generated contains the changes in the magnetic field that are caused by edges of a body or anomalies of the material properties. Anomalies of the material properties may be, inter alia, deviations in the conductivity and permeability, air inclusions and cracks. On account of using the time derivative, the method is referred to as a “differential” method. In particular, the method may be referred to as “motion-induced secondary field eddy current testing” (MISFECT).

Since, with a signal that is invariant over time (no material is undergoing testing, material is undergoing testing but there is no defect), the voltage is zero and a voltage is only measured if there are changes, it is sufficient to cover a small measuring range to detect defects. The high resolution of the measuring system that is then possible provides an increase in the probability of defect detection. Such a sensor is passive, since no energy supply is necessary, and it is immune to overloading, since only small electrical voltages that cannot destroy the sensor are induced.

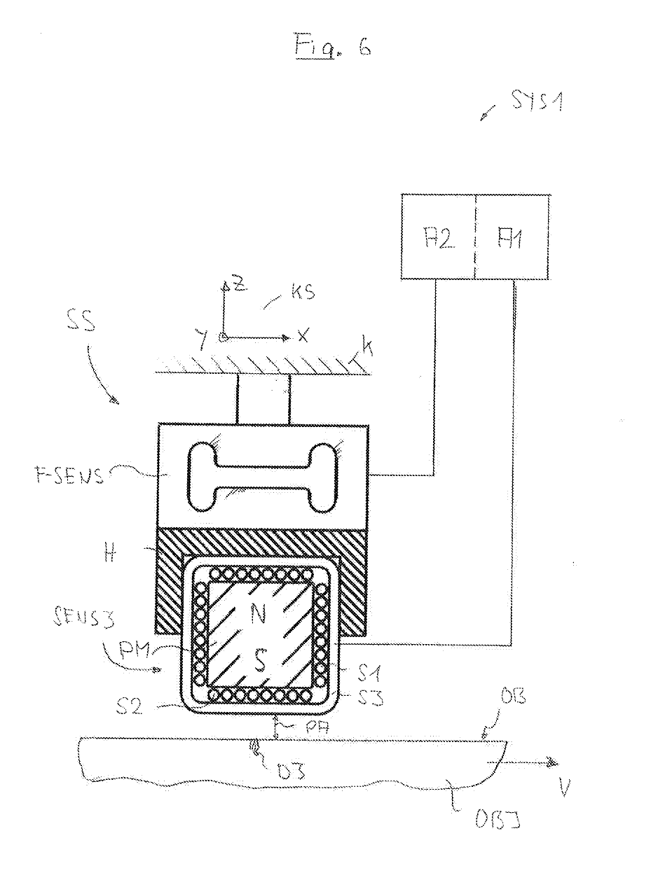

For purposes of illustration, FIG. 5 shows induced voltage signals in the coils with differing orientation, where 5A shows the signal of the second coil with a coil axis in the x direction (direction of movement) and FIG. 5B shows the signal of the first coil with a coil axis in the z direction (lifting direction).

The time correlation of two or more voltage signals can be used to reduce pseudo-rejection (badly inspected parts that are good). Since the change in the magnetic field should occur simultaneously in multiple coils, defect signals that only occur in one component of the sensor can be ignored.

By contrast with Lorentz force eddy current testing, magnetic forces of attraction no longer disturb the measuring system. Correspondingly, with the motion-induced secondary field eddy current testing presented here it is also possible to investigate ferromagnetic materials with a high degree of sensitivity and a high testing rate.

Differential eddy current sensors of the type described so far can be used advantageously in combination with a multi-component Lorentz force eddy current sensor that is designed for sensing the components of the absolute value of the induced Lorentz force in the respective spatial directions. On account of the relationship between the two methods, as a result it is possible, inter alia, to perform at the same time as the non-destructive testing for defects also for example a measurement of the specific electrical conductivity of the material being tested.

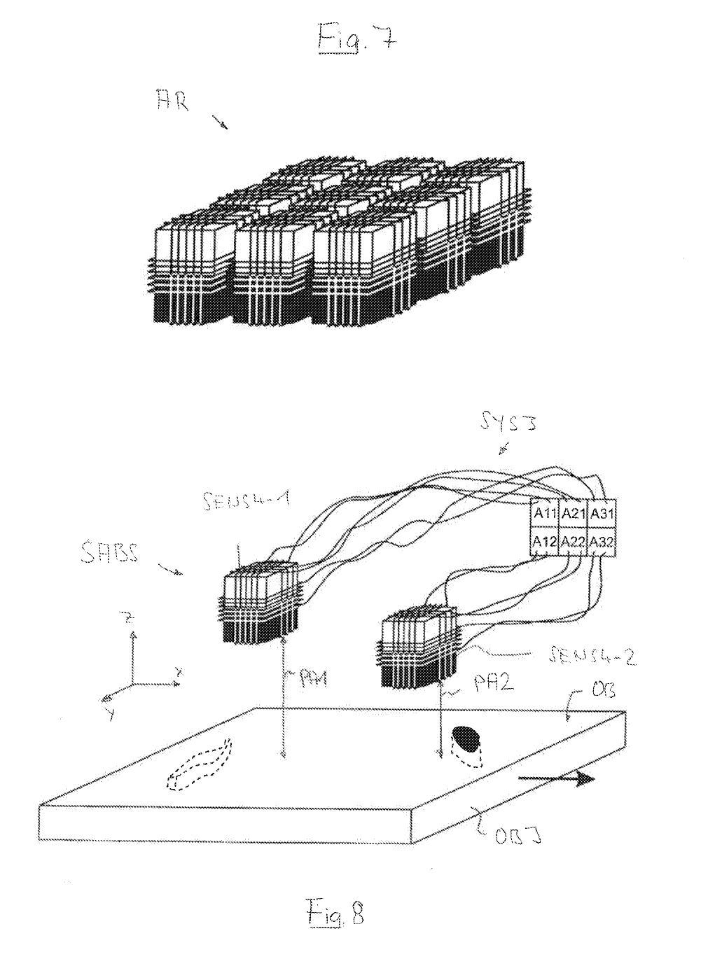

For purposes of illustration, FIG. 6 schematically shows essential components of an inspection system SYS1 configured for such combined testing. The combination sensor SS or the sensor combination SS of this inspection system has a differential sensor SENS3 for sensing the change in the magnetic flux in three dimensions, the structure and function of which may correspond to those of the sensor SENS1 from FIG. 1 or 2. Corresponding components bear the same designations as in FIGS. 1 and 2. Reference is made to the description in this respect. The three coils S1, S2, S3, wound orthogonally to one another around the permanent magnet PM, are connected separately from one another to a first evaluation device A1.

The sensor SENS3 is fastened with the aid of a holding device H of an electrically non-conducting, non-magnetizable material to the underside of a force sensor F-SENS and is thereby coupled to it in a mechanically fixed manner. The holding device may for example be formed by a plastic encapsulation of the sensor SENS3 that is adhesively attached to a suitable connection area of the force sensor or is screwed to it. The force sensor F-SENS is coupled in a mechanically rigid manner to a component K of the inspection system SYS1 that is installed in a spatially fixed manner, the spatial position and orientation of which can be described by the spatially fixed system of coordinates KS.

The force sensor is schematically represented by a deformation body of low mechanical stiffness, the extension or compression or twisting of which can be sensed on the basis of external forces by way of strain gages or other electromechanical transducers, it being possible for the electrical transducer signals to be taken as a basis for calculating back to the forces causing the deformation. The force sensor is connected to a second evaluation device A2, with which associated values for the force effect in the three spatial directions can be determined.

In the case of the example, the combination sensor SS is arranged at a small inspection distance PA above the surface OB of the metallically conducting test object OBJ, which in relation to the combination sensor SS at rest moves at the speed v parallel to the x direction.

The test object may be, for example, a metallic plate with a leading edge and a trailing edge (seen in the direction of movement) and a defect D3 near the surface. FIGS. 4 and 5 schematically show possible sensor signals without a defect (solid lines) and with a defect (dashed line) in two dimensions, specifically on the one hand parallel to the running-through direction (x direction) in FIGS. 4A and 5A and in the z direction, that is to say in the lifting direction perpendicular to the surface of the test piece, in FIGS. 4B and 5B.

The force signal Fₓ in the direction of movement increases to a finite value when it reaches the leading edge and then remains at a substantially constant level until the rear edge passes the sensor and the signal falls again to zero. This signal, corresponding to a drag force, drops slightly in the plateau region in the presence of a defect, since the defect disturbs the eddy current propagation in the material, and consequently the secondary field. When there is a lifting force (FIG. 4B), the edges are manifested as great, oppositely oriented deflections, whereas the defect occurring in between brings about an approximately sinusoidal disturbance of the signal that is small in comparison.

The voltage signals generated in the differential sensor SENS3 have a different profile. According to FIG. 5A, the edges of the body are manifested by the voltage signal of the second coil S2, the coil axis of which runs in the x direction, by great deflections in opposite directions, whereas the voltage signal disappears when undisturbed material of the test piece in between runs through. If a defect runs through the sensor range, the approximately sinusoidal defect signal is produced. That component of the changes in the magnetic flux that acts perpendicularly to the surface of the test piece, that is to say in the lifting direction, is sensed by the first coil S1, the coil plane of which runs parallel to the surface of the test piece. The leading and trailing edges thereby produce oppositely oriented, great, distorted sinusoidal deflections. In the defect-free region in between, the voltage falls to zero. If a defect occurs, it is manifested as a distortedly sinusoidal deflection of the voltage signal.

Both types of signals, that is to say the signal of the force sensor F-SENS, attributable to the force effects, and the induced electrical voltages of the differential sensor SENS3, are evaluated in the inspection system SYS1 in order to obtain findings about the material being tested. The presence or absence of defects is determined with a high degree of sensitivity and high dynamics with the aid of the first evaluation unit Al from the sensor signals of the differential sensor SENS3. At the same time, the specific electrical conductivity of the material of the test piece is determined for the same test volume from the signals of the force sensor. This involves the forming of a quotient F_{z}/Fₓ, the dividend of which is a measure of the force effect in the lifting direction (F_{z}) and the divisor of which is a measure of the force effect parallel to the direction of movement, that is to say a measure of the drag force (Fₓ). On the basis of these measured values, the electrical conductivity of the material of the test piece can be determined according to the method described in DE 10 2011 056 650 A1. When doing so, influences of the magnetic flux density of the magnet and of the distance between the permanent magnet and the material on the result of the measurement can be minimized by the forming of the quotient, so that contactless determination of the electrical conductivity is possible with a high degree of accuracy. The disclosure content in this respect of DE 10 2011 056 650 A1 is to this extent made the content of this description by reference.

The combination inspection system SYS1 or the combination sensor SS has a mechanically and electrically relatively simple and robust structure and may for example be used for the certification of electrically conductive materials directly in connection with production, in order apart from the highly dynamic and sensitive inspection for defects also to make precise quantitative statements about the electrical conductivity. Such combination sensors may be used for example with great advantage in the production of aluminum, and replace previous separate methods of inspection.

In the case of some embodiments, an inspection system has a sensor system with two or more differential sensors, the structure of which may be similar or identical to one another.

FIG. 7 shows a sensor system in the form of a sensor array AR with multiple, for example nine, differential sensors identical to one another, which are relatively close together in a two-dimensional planar array arrangement in a rectangular grid, in order to be able for example to sense relatively extensive regions of a material to be tested simultaneously. It is also possible for fewer or more sensors, for example from 4 sensors to 20 sensors or more, to be provided in a sensor array.

An individual differential sensor has for each component (of the change in the magnetic flux) a characteristic imaging function (point spread function). So if multiple sensors are operated in a sensor array and the signals of the individual sensors are correlated with the position of the sensor by way of at least one evaluation algorithm, an at least two-dimensional (2D), preferably three-dimensional (3D), imaging of the test material being investigated can be created. The use of further evaluation algorithms can lead to a 3D reconstruction of defects. On account of their compact construction, differential sensors can consequently also be used well for imaging methods of inspection or measuring methods.

At least two single differential sensors may be used to compensate for disturbing influences, for example components of changes in the inspection distance. For this purpose, the distance behavior (dependence of the signal amplitude on the inspection distance) of a single sensor must be known as well as possible. So if two single sensors are operated with two different inspection distances, it can be determined by what amounts the inspection distance changes and the measuring signal can be correspondingly corrected (distance compensation).

Such a possibility for using multiple differential sensors in an inspection system SYS3 is explained on the basis of FIG. 8. The sensor system SABS has a first differential sensor SENS4-1 and a second differential sensor SENS4-2 of an identical construction. Still further differential sensors, which are not represented, may be additionally provided. The two sensors may for example be integrated in a sensor array. The signals of the three coils respectively of each of the sensors are sensed separately in assigned evaluation units Aij, with i=1, 2, 3 and j=1, 2, 3, and then correlated. The two sensors are offset with respect to one another in the z direction, so that they are not at the same height with respect to the test object OBJ when the sensor system is positioned in the vicinity of the surface OB of the test piece. A first inspection distance PA1 is greater than the second inspection distance PA2. By common evaluation of the sensor signals, an inspection system with distance compensation can be created.

In the case of the graphically represented embodiments, the permanent magnet is a magnet comprising at least one piece of a magnetizable material that obtains its static magnetic field without an electrical current flow being required to generate the magnetic field, as in the case of electromagnets. The permanent magnet is a currentlessly operating constant magnetic field source. Some advantages of the claimed invention would possibly also be achievable with a constant magnetic field source that has at least one coil through which direct current flows, where this coil should as far as possible be connected to a constant current source to achieve a constant magnetic field. To the extent to which the advantages described here are substantially obtained, the term “permanent magnet” refers in the broader sense to a constant magnetic field source.

Moreover, it is not imperative that the magnetic axis of the permanent magnet or of the constant magnetic field source is as perpendicular as possible to the surface of the test object. An inclined orientation or an orientation parallel to the surface of the test object is also possible. However, among the reasons why the perpendicular orientation may be particularly favorable is the higher field strengths that are achievable.

In the case of the graphically represented embodiments, the coils of differing orientation act as magnetic field sensors that generate a sensor signal in the form of an induced voltage when there is a change in the magnetic field acting on the coils. To this extent, the term “coil” stands in the broader sense for a sensor that is sensitive to changes in the magnetic field, that is to say a sensor which, when there is a change in a magnetic field acting on the sensor, generates a sensor signal proportional to this change, for example in the form of an electrical voltage signal. One, some or all of the coils may possibly also be replaced by another sensor that is sensitive to changes in the magnetic field, for example by a Hall sensor or a superconducting quantum interference unit (SQUID).

According to another formulation, a differential sensor for the detection of anomalies in electrically conductive materials is provided, comprising:

a constant magnetic field source;

a first sensor, which is sensitive to changes in the magnetic field and defines a first sensor axis;

and at least one second sensor, which is sensitive to changes in the magnetic field and defines a second sensor axis, which runs transversely, in particular, perpendicularly, to the first sensor axis,

a sensor axis respectively being the direction of maximum sensitivity of the sensor to changes in the magnetic field.

1-13. (canceled)

14. A differential sensor for the detection of anomalies in electrically conductive materials, comprising:
a permanent magnet;
a first coil with one or more first windings, which run around the permanent magnet and define a first coil axis, and
a second coil with one or more second windings, which run around the permanent magnet and define a second coil axis, which runs transversely to the first coil axis.

15. The differential sensor as claimed in claim 14, further comprising a third coil with one or more third windings, which run around the permanent magnet and define a third coil axis, which runs transversely to the first coil axis and to the second coil axis.

16. The differential sensor as claimed in claim 15, wherein the coil axes are alternately oriented perpendicularly to one another.

17. The differential sensor as claimed in claim 15, wherein the first coil, the second coil and the third coil are fixed to the permanent magnet.

18. The differential sensor as claimed in claim 14, wherein the differential sensor is mechanically coupled to a force sensor in such a way that Lorentz forces acting on the differential sensor can be sensed in multiple spatial directions by means of the force sensor.

19. An inspection system for the detection of anomalies in electrically conductive materials, comprising:
at least one differential sensor comprising:
a permanent magnet;
a first coil with one or more first windings, which run around the permanent magnet and define a first coil axis, and
a second coil with one or more second windings, which run around the permanent magnet and define a second coil axis, which runs transversely to the first coil axis; and
an evaluation device, which is configured for sensing separately for each coil electrical voltages induced in the windings of the coils of the differential sensor, or signals derived therefrom, and correlating them by applying at least one evaluation method.

20. The inspection system as claimed in claim 19, wherein the evaluation device is configured only to generate a defect signal, indicating a defect, whenever a change in voltage that is typical of a defect is induced in the first coil and in the second coil.

21. The inspection system as claimed in claim 20, further comprising:
a force sensor, which is mechanically coupled to the differential sensor in such a way that Lorentz forces acting on the differential sensor can be sensed in multiple spatial directions by the force sensor, and
an evaluation device for the evaluation of signals of the force sensor for multiple spatial directions.

22. The inspection system as claimed in claim 21, wherein the evaluation of the signals of the force sensor involves the forming of a quotient, the dividend of which is a measure of the force effect perpendicular to the surface of the test piece and the divisor of which is a measure of the force effect parallel to the direction of movement.

23. The inspection system as claimed in claim 19, wherein the inspection system has a sensor system with at least two differential sensors, which are arranged offset with respect to one another in such a way that they are at different inspection distances from a test object when the sensor system is positioned in the vicinity of the surface of the test piece.

24. The inspection system as claimed in claim 19, wherein the evaluation device is configured for distance compensation.

25. The inspection system as claimed in claim 19, wherein multiple differential sensors form a one-dimensional or two-dimensional sensor array.

26. A method for detecting anomalies in electrically conductive materials, using a differential sensor and/or using an inspection system, the method comprising the steps of:
arranging the differential sensor in the vicinity of a surface of a test object of electrically conductive material such that a magnetic field generated by a permanent magnet of the sensor can penetrate into the test object to a penetration depth;
generating a relative movement between the differential sensor and the test object of the electrically conducting material parallel to a direction of movement;
sensing, separately for each coil, electrical voltages induced in the windings of at least first and second coils of the differential sensor, or signals derived therefrom; and
evaluating the electrical voltages induced in the coils, or signals derived therefrom, by applying at least one evaluation method.
